(19) United States
(12) Patent Application Publication
(10) Pub. No.: US 2005/0262644 A1
(43) Pub. Date: Dec. 1, 2005

(54) Washing machine having deodorizing means and control method thereof

(76) Inventors: Seong Min Oak, Masan City (KR); Hyung Gyoon Kim, Suwon-Si (KR); Sang Yeon Pyo, Suwon-Si (KR); Hye Soon Yang, Yongin-Si (KR); Jae Ryong Park, Suwon-Si (KR); Byoung Yull Yang, Ansan-Si (KR)

Correspondence Address: STAAS & HALSEY LLP, SUITE 700, 1201 NEW YORK AVENUE, N.W., WASHINGTON, DC, 20005, US

(21) Appl. No.: 11/114,241

(22) Filed: Apr. 26, 2005

(30) Foreign Application Priority Data
May 25, 2004 (KR) 2004-37159

(51) Int. Cl. B08B 3/12

(52) U.S. Cl. 8/158; 68/5 R; 68/23 R; 68/15; 68/16

(57) ABSTRACT

A washing machine which deodorizes an object placed in the washing machine using functional water independently of a washing process, and a control method thereof. The washing machine includes a tub to contain wash water therein, a drum rotatably installed in the tub, and deodorizing means which includes a functional water producing unit to produce functional water having a deodorizing effect, a heating tank to receive and to heat the functional water, and a steam supply pipe to supplying steam obtained from the functional water heated by the heating tank, to an object placed in the drum to be deodorized.

### CROSS-REFERENCE TO RELATED APPLICATIONS

This application claims the benefit of Korean Patent Application No. 2004-37159, filed May 25, 2004, in the Korean Intellectual Property Office, the disclosure of which is incorporated herein by reference.

### BACKGROUND OF THE INVENTION

1. Field of the Invention

The present invention relates to a washing machine having deodorizing means and a control method thereof, and more particularly to a washing machine having deodorizing means to remove odor from objects to be deodorized and a control method of the washing machine.

2. Description of the Related Art

Generally, washing machines are apparatuses for removing contaminants from clothes using friction between water and the clothes, and are divided to various types based on washing methods. A drum type washing machine, which has been widely used, includes a tub having a cylindrical structure to contain wash water, a drum having a cylindrical structure rotatably installed in the tub, a motor to rotate the drum, a water supply unit to supply water to the drum, and a drying unit to dry laundry placed in the drum.

When washing instructions are inputted to the conventional drum type washing machine, a microcomputer supplies wash water to the drum using the water supply unit, performs washing, rinsing and spin-drying operations, and supplies hot air to the drum using the drying unit so that clothes placed in the drum are dried.

The conventional drum type washing machine does not include deodorizing means. Therefore, when particles of offensive odor, such as the smell of tobacco or food are attached to clothes, the conventional drum type washing machine merely performs washing/rinsing/spin-drying/drying operations of the clothes to attempt to remove the odor from the clothes. Accordingly, the conventional drum type washing machine is disadvantageous in that it increases wear-and-tear of the clothes with the increased washing frequency, and requires unnecessary consumption of electric power.

### SUMMARY OF THE INVENTION

Accordingly, it is an aspect of the invention is to provide a washing machine having deodorizing means, which removes offensive odor from objects to be deodorized, and a control method thereof.

Additional aspects and/or advantages of the invention will be set forth in part in the description which follows and, in part, will be apparent from the description, or may be learned by practice of the invention.

The foregoing and or other aspects of the present invention are achieved by providing a washing machine having deodorizing means, which performs a deodorizing operation independently of a washing operation, and a control method thereof.

It is an aspect of the present invention to provide a washing machine having a main body, the washing machine including a tub to contain wash water therein, a drum rotatably installed in the tub, deodorizing means installed in the main body and including a functional water producing unit to produce functional water having a deodorizing effect, a heating tank to receive and to heat the functional water, and a steam supply pipe to supply steam, obtained from the functional water heated by the heating tank, to an object placed in the drum to be deodorized, and a control unit to control the deodorizing means to perform a deodorizing mode independently of a washing process of the washing machine,

It is another aspect of the present invention to provide a control method of a washing machine, the method including determining whether a deodorizing signal is inputted; and supplying steam, obtained by heating functional water having a deodorizing effect, to a drum of the washing machine, when it is determined that the deodorizing signal is inputted.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a drum type washing machine in accordance with an embodiment of the present invention;

FIG. 2 is a cross-sectional view of a steam generating unit of the drum type washing machine shown in FIG. 1;

FIG. 3 is a block diagram illustrating the drum type washing machine shown in FIG. 1;

FIG. 4 is a flow chart illustrating an operation of the drum type washing machine shown in FIG. 3;

FIG. 5 is a perspective view of a drum type washing machine in accordance with another embodiment of the present invention;

FIG. 6 is a block diagram illustrating the drum type washing machine shown in FIG. 5; and

FIG. 7 is a flow chart illustrating an operation of the drum type washing machine shown in FIG. 6.

### DETAILED DESCRIPTION OF THE PREFERRED EMBODIMENTS

Reference will now be made in detail to the embodiments of the present invention, an example of which is illustrated in the accompanying drawings, wherein like reference numerals refer to the like elements throughout. The embodiments are described below to explain the present invention by referring to the figures.

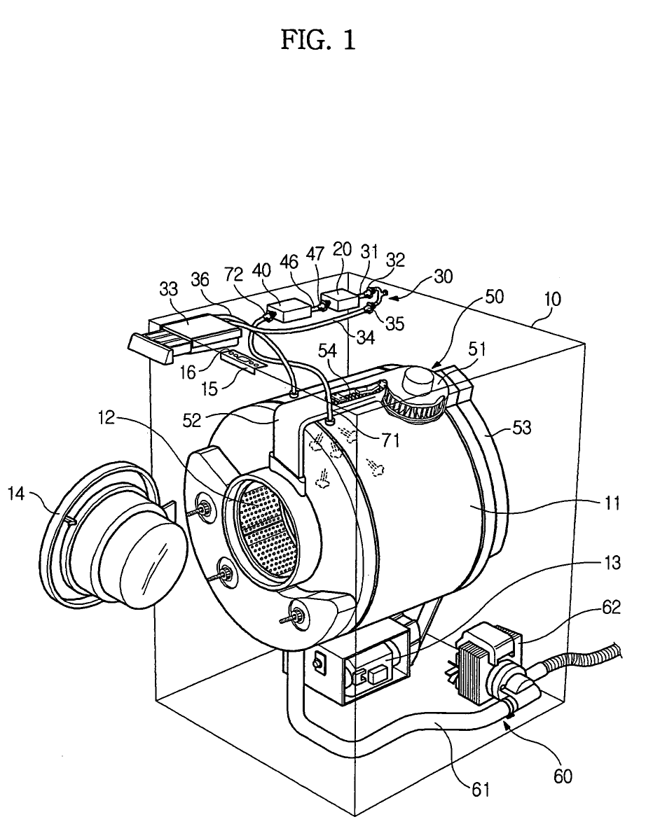

FIG. 1 illustrates a drum type washing machine, in accordance with an embodiment of the present invention, the drum type washing machine having a main body 10 the drum type washing machine comprising a tub 11 having a cylindrical structure installed in the main body 10 to contain wash water therein, a drum 12 having a cylindrical structure rotatably installed in the tub 11 and provided with a plurality of drain holes formed through a wall thereof, a driving motor 13 to rotate the drum 12 in a clockwise or counterclockwise direction, a door 14 to open the main body 10 to put laundry into and take laundry out of the washing machine, and an input unit 15 placed on an upper part of a front surface of the main body 10 and including a plurality of keys. A deodorizing button 16 to input deodorizing instructions therethrough, is placed on the input unit 15.

The drum type washing machine further comprising a silver solution producing unit 20 to produce a silver solution to deodorize the laundry placed in the drum 12, a water supply unit 30 to supply water to the silver solution producing unit 20, a steam generating unit 40 to generate steam by heating the silver solution, a drying unit 50 to dry laundry, and a drain unit 60 to forcibly discharge wash water from the tub 11.

Various types of the silver solution producing unit 20 are manufactured now. Generally, in silver solution producing devices, two silver bars are soaked in water and current is supplied between the two silver bars, thereby producing a silver solution. The silver solution producing unit 20 is disclosed in detail by Korean Utility Model Laid-open No. 2001-001169 and Korean Patent Laid-open No. 2004-0004267.

The water supply unit 30 comprises a first water supply pipe 31 to supply water to the silver solution producing unit 20, a first water supply valve 32 to control the quantity of water flowing in the first water supply pipe 31, a second water supply pipe 34 to supply water to a detergent dissolving unit 33, a second water supply valve 35 to control the quantity of water flowing in the second water supply pipe 34, and a third water supply pipe 36 to supply water containing a detergent dissolved therein to the tub 11.

The drying unit 50 comprises an air blast fan 51 installed on an upper part of the tub 11, a discharge duct 52 interposed between an outlet of the air blast fan 51 and an opening of the tub 11, a condensing duct 53 interposed between an air outlet installed through a lower part of a rear portion of the tub 11 and an inlet of the air blast fan 51, and a heater 54 installed in the discharge duct 53.

The drain unit 60 is installed in the lower part of the main body 10 and comprises a drain pipe 61 and a drain pump 62.

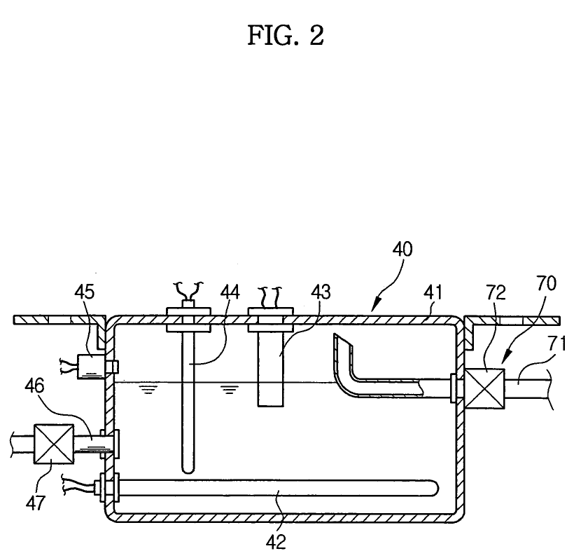

As shown in FIG. 2, the steam generating unit 40 comprises a heating tank 41 having a sealed container to contain a predetermined quantity of the silver solution, and a heater 42 to heat the silver solution in the heating tank 41, to thereby generate steam. The steam generating unit 40 further comprises a water level sensor 43 to control a water level in the heating tank 41, a temperature sensor 44 to control a temperature in the heating tank 41, and a pressure sensor 45 to control a pressure in the heating tank 41. The water level sensor 43, the temperature sensor 44 and the pressure sensor 45 are installed on an upper part of the heating tank 41.

A connection pipe 46, to supply the silver solution produced by the silver solution producing unit 20 to the heating tank 41, is connected with a side surface of the heating tank 41, and a steam supply unit 70, to supply steam to the tub 11 is installed on another side surface of the heating tank 41. A connection valve 47 is installed in the connection pipe 46, to thereby control a quantity of the silver solution flowing in the connection pipe 46.

The steam supply unit 70 comprises a steam supply pipe 71 to guide steam from an inside of the heating tank 41 to an inside of the tub 11, a steam supply valve 72 installed in the steam supply pipe 71 to control the quantity of the supplied steam, and a steam diffusion pump (not shown) installed at an outlet of the steam supply pipe 71 to guide an ejection of the steam supplied to the tub 11, by diffusion. The steam supply pipe 71 is extended to the inside of the heating tank 41 and is then bent upwardly so that an inlet of the steam supply pipe 71 is located in the upper part of the heating tank 41, thereby allowing only the steam in the heating tank 41 to flow therethrough.

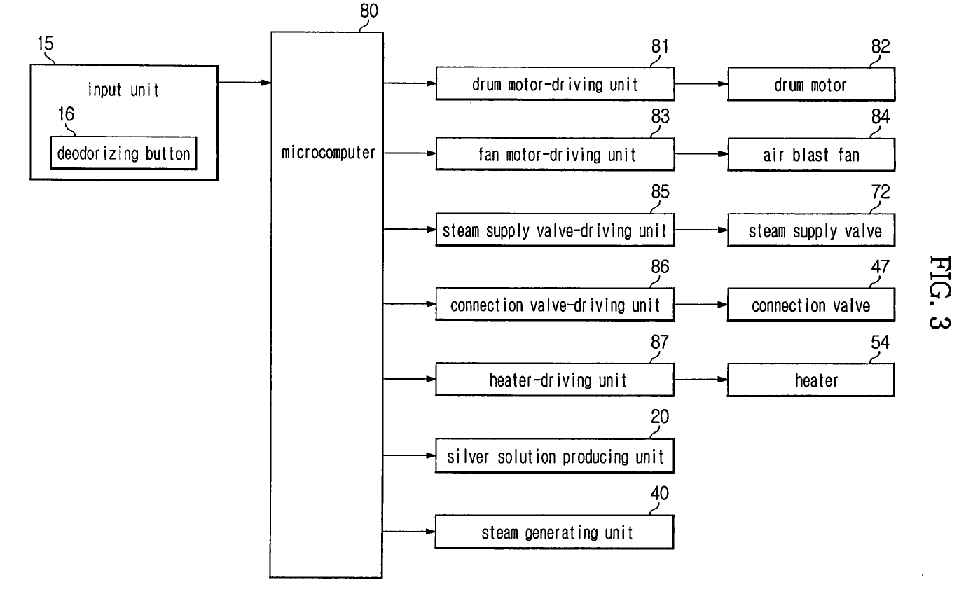

The drum type washing machine in accordance with an embodiment of the present invention, as shown in FIG. 3, further comprises, a drum motor-driving unit 81 to drive a drum motor 82 for rotating the drum 12, a fan motor-driving unit 83 to rotate an air blast fan motor 84 rotating the air blast fan 51 to forcibly blow air to the drum 12, a steam supply valve-driving unit 85 to drive the steam supply valve 72, a connection valve-driving unit 86 to drive the connection valve 47, a heater-driving unit 87 to drive the heater 54, and a microcomputer 80 to control the above various components.

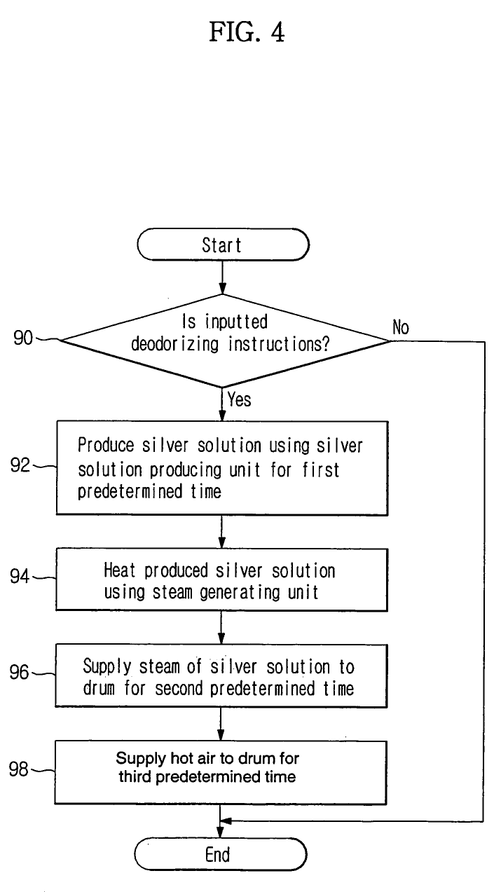

Hereinafter, with reference to FIG. 4, an operation of the drum type washing machine shown in FIG. 3 will be described. In operation 90, the microcomputer 80 determines whether deodorizing instructions are inputted by a user. The deodorizing instructions are inputted to the washing machine by pressing the deodorizing button 16 installed on the input unit 15 by the user after clothes having an offensive odor are put into the drum 12, to be deodorized.

When it is determined in operation 90, that the user's deodorizing instructions are not inputted to the washing machine, the microcomputer 80 terminates a corresponding cycle, and when it is determined that the user's deodorizing instructions are inputted to the washing machine, the microcomputer 80 performs a deodorizing mode in operation 92. The deodorizing mode in this embodiment of the present invention is performed independently of a washing process. However, the deodorizing mode may be performed continuously after the washing process, or may be performed without the washing process.

For example when the user presses both a washing button (not shown) and the deodorizing button 16 installed on the input unit 15, the deodorizing operation is performed after washing/rinsing/spin-drying/drying operations are performed. On the other hand, when the user presses only the deodorizing button 16, only the deodorizing operation is performed without washing/rinsing/spin-drying/drying operations.

In order to perform the deodorizing mode in operation 92, the microcomputer 80 opens the first water supply valve 32 so as to supply water to the silver solution producing unit 20, and, when a water level in the silver solution producing unit 20 exceeds a reference water level, closes the first water supply valve 32 and applies voltage to the silver solution producing unit 20 for a first predetermined time so as to produce a silver solution. Here, the connection valve 47 is closed so that the silver solution produced by the silver solution producing unit 20 is not supplied to the steam generating unit 40 until the silver solution reaches a designated concentration, and the first predetermined time is set in consideration of a time taken for the silver solution produced by the silver solution producing unit 20 to have the designated concentration.

After the first predetermined time has elapsed, the microcomputer 80 opens the connection valve 47 so as to supply the silver solution produced by the silver solution producing unit 20 to the steam generating unit 40. The microcomputer 80 senses a water level in the steam generating unit 40 during a time when the silver solution is supplied to the steam generating unit 40, and, when the level of the silver solution supplied to the steam generating unit 40 exceeds a reference level, closes the connection valve 47. Here, the steam supply valve 72 maintains its closed state.

In operation 94, after the supply of the silver solution is completed, the microcomputer 80 drives the heater 54 so as to heat the silver solution, and the heated silver solution is gradually vaporized into steam. From operation 94, the process moves to operation 96, where when the pressure generated by the steam, in the steam generating unit 40 sensed by the pressure sensor 45 reaches a steam supply pressure, the microcomputer 80 opens the steam supply valve 72 for a second predetermined time so as to supply the steam to the tub 11. The steam which is supplied to the tub 11, is bonded to particles of offensive odor permeating clothes placed in the drum 12 (for example, such as the smell of tobacco, food, etc). The steam, which is bonded to the particles of odor, is deodorized by decomposition of the particles of odor using silver (Ag), and various impurities of the clothes are sterilized by silver (Ag).

When the steam is supplied to the tub 11, the drum 12 may be rotated so that silver is more easily bonded to the particles of odor. The second predetermined time may be set to a proper value by experiments.

From operation 96, the process moves to operation 98, where the microcomputer 80 drives the heater 54 and the air blast fan 51 for a third predetermined time. When the heater 54 and the air blast fan 51 are driven, air discharged from the air blast fan 51 is heated by the heater 54 and supplied to the inside of the tub 11 through the discharge duct 52. The obtained hot air, which is supplied to the inside of the tub 11, vaporizes moisture remaining in the clothes into steam, and the steam is transmitted to the condensing duct 53 through the hot air, condensed by the condensing duct 53, and is then discharged to the outside of the drum type washing machine. The hot air transmits the particles of odor, which are not decomposed by silver, and the transmitted particles of odor together with the steam are condensed by the condensing duct 53 and discharged to the outside of the drum type washing machine. Thereby, it is possible to remove offensive odor from clothes without an additional washing process.

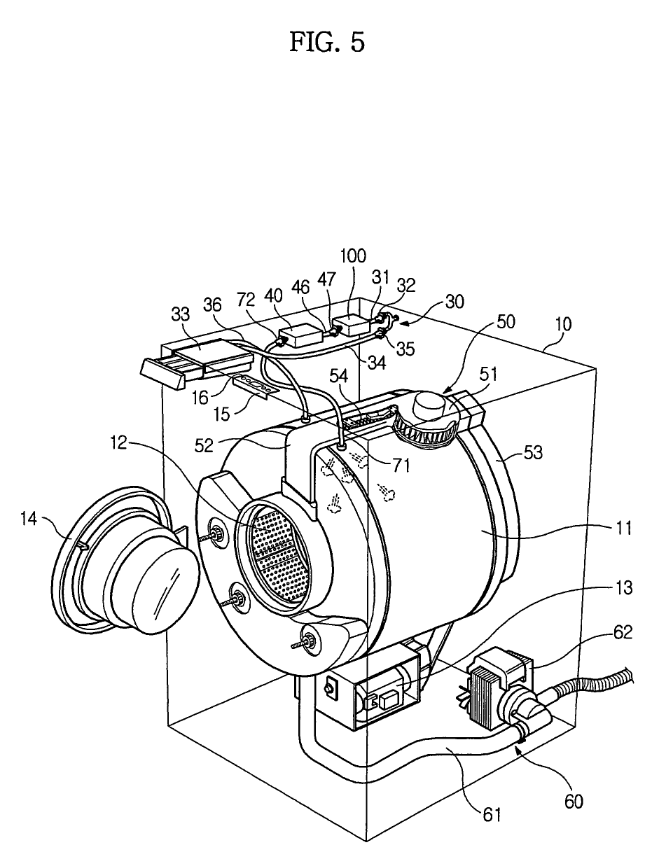

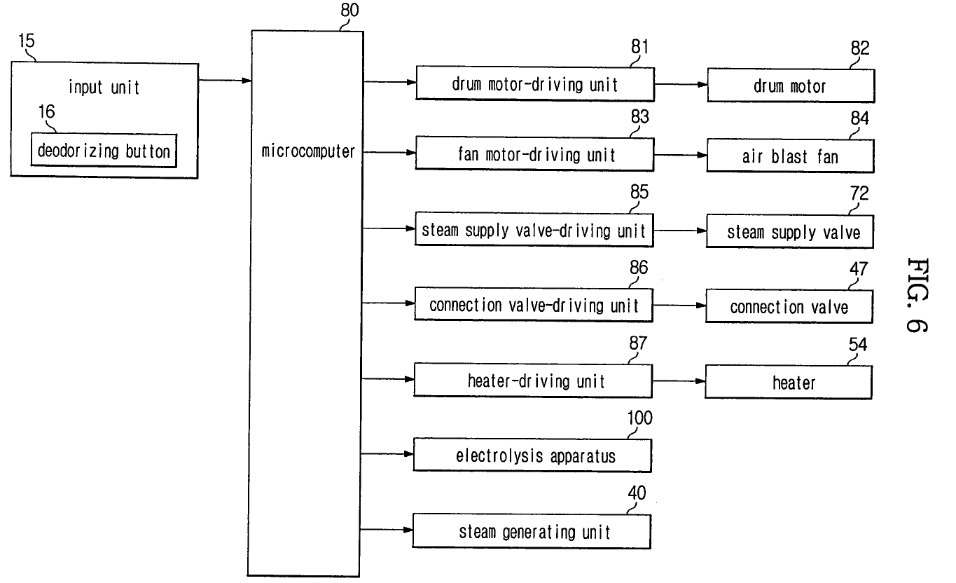

FIGS. 5 and 6 illustrate a drum type washing machine in accordance with another embodiment of the present invention. The drum type washing machine in this embodiment differs from the drum type washing machine in the other embodiment in that electrolyzed water is used as functional water.

That is, in the drum type washing machine in this embodiment, differently from the drum type washing machine in the other embodiment (as shown in FIG. 1), acid water generated by an electrolysis apparatus 100 (in FIG. 5) is supplied to the steam generating unit 40. The acid water (electrolyzed water) has deodorizing and sterilizing effects similar to the silver solution, and the electrolysis apparatus 100 is disclosed in detail by Korean Patent Laid-open 2003-0060302 and Korean Utility Model Publication No. 20-0296928.

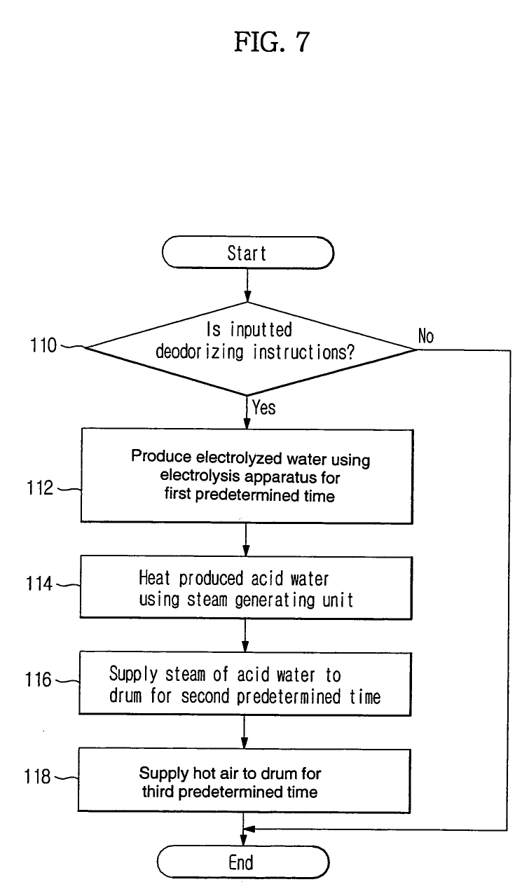

FIG. 7 is a flow chart illustrating an operation of the drum type washing machine shown in FIG. 6. The operation of the drum type washing machine in accordance with the embodiment shown in FIG. 7 is similar to that of the drum type washing machine in accordance with the embodiment shown in FIG. 4. However, the operation of the drum type washing machine in accordance with this embodiment as shown in FIG. 7 differs from that of the drum type washing machine in accordance with the embodiment shown in FIG. 4, in that the acid water instead of the silver solution is supplied to the steam generating unit 40. Thus, in FIG. 7, operations 110, 114, 116 and 118 correspond respectively to operations 90, 94, 96 and 98 shown in FIG. 4. However, operation 112 differs from operation 92 shown in FIG. 4, in that electrolyzed water is produced instead of silver solution.

As apparent from the above description, the present invention provides a washing machine having deodorizing means to deodorize an object using functional water, and a control method thereof.

Further, the washing machine of the present invention and the control method thereof, provide an advantage of simply and rapidly performing a deodorizing mode independent of performing a washing process.

Although few embodiments of the invention have been shown and described, it would be appreciated by those skilled in the art that changes may be made in these embodiments without departing from the principles and spirit of the invention, the scope of which is defined in the claims and their equivalents.

1. A washing machine having a main body comprising:
a tub to contain wash water therein;
a drum rotatably installed in the tub;
deodorizing means installed in the main body, to deodorize an object placed in the drum; and
a control unit to control the deodorizing means to perform a deodorizing mode independently of a washing process,
wherein the deodorizing means comprises
a functional water producing unit to produce functional water having a deodorizing effect;
a heating tank to receive and to heat the functional water; and
a steam supply pipe to supply steam, obtained from the functional water heated by the heating tank, to the object placed in the drum to be deodorized.

2. The washing machine according to claim 1, further comprising input means to input deodorizing instructions therethrough.

3. The washing machine according to claim 1, further comprising:
a water supply pipe connected with the functional water producing unit to supply water thereto;
a water supply valve installed in the water supply pipe to control a flow of water therein; and
a connection pipe and connection valve, wherein the functional water producing unit is connected to the heating tank by the connection pipe, and the connection valve is installed in the connection pipe to control the flow of the functional water.

4. The washing machine according to claim 1, wherein the functional water producing unit is a silver solution producing unit for producing silver solution.

5. The washing machine according to claim 1,
wherein the functional water producing unit is an electrolysis apparatus for producing electrolyzed water.

6. The washing machine according to claim 1, further comprising a drying unit for supplying hot air to the drum.

7. The washing machine according to claim 6, wherein the drying unit comprises:
an air blast fan to supply air to the tub;
a discharge duct connecting an outlet of the air blast fan and an opening of the tub, to discharge air supplied from the air blast fan into the tub;
a condensing duct connecting an air outlet installed through a lower part of a rear portion of the tub and an inlet of the air blast fan to condense water; and
a heater installed in the discharge duct to heat the air supplied from the air blast fan.

8. A control method of a washing machine having deodorizing means comprising:
determining whether a deodorizing signal is inputted; and
supplying steam obtained by heating functional water having a deodorizing effect, to a drum of the washing machine, when it is determined that the deodorizing signal is inputted.

9. The control method according to claim 8, wherein the supplying of the steam to the drum is performed independently of a washing process.

10. The control method according to claim 8, further comprising supplying hot air to the drum after the supplying of the steam to the drum.

11. A washing machine comprising:
a tub to contain water therein;
a drum rotatably installed in the tub, to place laundry therein; and
a deodorizing unit to deodorize the laundry placed in the drum independently of a washing process of the washing machine.

12. The washing machine of claim 11, wherein the deodorizing unit comprises:
a water producing unit to produce water containing a deodorizer;
a heating unit connected with the water producing unit, to heat the water in the water producing unit;
a steam supplying unit to produce and to supply steam from the heated water to the laundry placed in the drum, to be deodorized.
